(19) United States
(12) Patent Application Publication
(10) Pub. No.: US 2010/0102471 A1
(43) Pub. Date: Apr. 29, 2010

(54) FLUID TRANSPORT AND DISPENSING

(75) Inventors: Van Nguyen Truskett, Austin, TX (US); Steven C. Shackleton, Austin, TX (US)

Correspondence Address: MOLECULAR IMPRINTS, PO BOX 81536, AUSTIN, TX, 78708-1536, US

(73) Assignee: MOLECULAR IMPRINTS, INC., Austin, TX (US)

(21) Appl. No.: 12/603,819

(22) Filed: Oct. 22, 2009

Related U.S. Application Data
(60) Provisional application No. 61/108,146, filed on Oct. 24, 2008.
(60) Provisional application No. 61/109,535, filed on Oct. 30, 2008.

(51) Int. Cl. B29C 59/00; B29C 43/58; B67D 7/06; B67D 7/78

(52) U.S. Cl. 264/40.7; 425/145; 222/135; 222/144.5; 222/145.1

(57) ABSTRACT

Imprint lithography systems and methods for transporting and dispensing polymerizable material on a substrate are described. In one implementation, the transport system utilizes a dispense head, dispense guard, and a shielding block when dispensing the polymerizable material. In another implementation, the transport system comprises one or more filters positioned in an inline manifold for particle reduction or ion reduction.

### CROSS-REFERENCE TO RELATED APPLICATIONS

This application claims the benefit under 35 U.S.C. § 119(e)(1) of U.S. Provisional No. 61/108,146, filed Oct. 24, 2008, and U.S. Provisional No. 61/109,535, filed on Oct. 30, 2009, both of which are hereby incorporated by reference.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate; therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference.

An imprint lithography technique disclosed in each of the aforementioned U.S. patent publications and patent, includes formation of a relief pattern in a polymerizable layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### BRIEF DESCRIPTION OF SEVERAL VIEWS OF THE DRAWINGS

So that the present invention may be understood in more detail, a description of embodiments of the invention is provided with reference to the embodiments illustrated in the appended drawings. It is to be noted, however, that the appended drawings illustrate only typical embodiments of the invention, and are therefore not to be considered limiting of the scope.

FIG. 1 illustrates a simplified side view of a lithographic system in accordance with an embodiment of the present invention.

FIG. 2 illustrates a simplified side view of the substrate shown in FIG. 1 having a patterned layer positioned thereon.

FIG. 3 illustrates a simplified side view of a fluid dispensing system dispensing droplets on a substrate.

FIG. 4 illustrates a simplified side view of an exemplary fluid dispensing system.

FIG. 5 illustrates a simplified side view of droplets egressing from tips of the fluid dispense system of FIG. 4.

FIG. 6 illustrates exemplary arrangements for dispense heads within the fluid dispensing system of FIG. 4.

FIG. 7 illustrates a view of an exemplary dispense head guard protecting a tip of the fluid dispensing system of FIG. 4.

FIG. 8 illustrates an exemplary dispense head cap protecting a tip of the fluid dispense system of FIG. 4.

FIG. 9 further illustrates the exemplary dispense head guard protecting a tip of the fluid dispensing system of FIG. 7.

FIG. 10 illustrates a simplified side view of an exemplary shielding block positioned adjacent to the fluid dispensing system of FIG. 4.

FIG. 11 illustrates a simplified side view of an exemplary shielding block positioned on a stage.

FIG. 12 illustrates a simplified sectional view of an exemplary dispense system connected to an exemplary waste disposal system.

FIG. 13 illustrates exemplary mounting hardware for dispense heads.

FIG. 14 illustrates exemplary movement of a dispense head.

FIGS. 15-20 illustrate exemplary transport systems for a fluid dispensing system.

FIGS. 21-23 illustrate exemplary methods for providing fluid to a dispense head by a transport system.

FIG. 24 illustrates a flow chart of an exemplary method for dispensing droplets of polymerizable material to prevent clogging of a nozzle system.

FIG. 25 illustrates a flow chart of an exemplary method for collecting and evaluating gases from a fluid dispensing system.

FIG. 26 illustrates a flow chart of an exemplary method for flushing a fluid dispense system.

### DETAILED DESCRIPTION

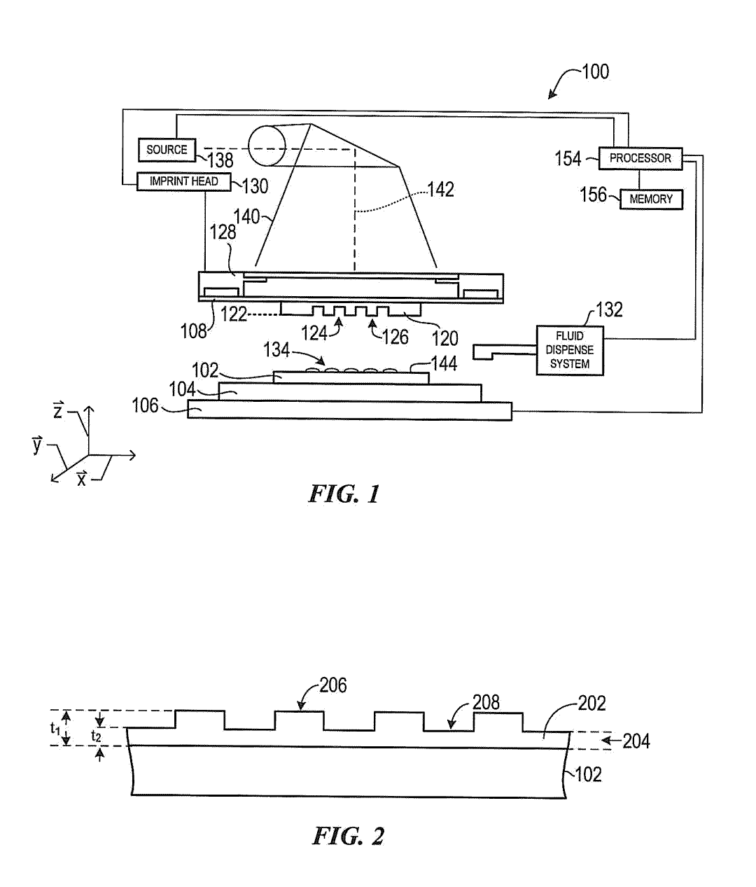

Referring to the figures, and particularly to FIG. 1, illustrated therein is a lithographic system 100 used to form a relief pattern on substrate 102. Substrate 102 may be coupled to substrate chuck 104. In one implementation, substrate chuck 104 is a vacuum chuck. Alternatively, substrate chuck 104 may be any chuck including, but not limited to, a vacuum, a pin-type, a groove-type, a electromagnetic, and/or the like. Exemplary chucks are described in U.S. Pat. No. 6,873,087, which is hereby incorporated by reference.

Substrate 102 and substrate chuck 104 may be further supported by stage 106. Stage 106 may provide motion along the x-, y-, and z-axes. Stage 106, substrate 102, and substrate chuck 104 may also be positioned on a base (not shown).

Spaced-apart from substrate 102 is a template 108. Template 108 includes a mesa 120 extending therefrom towards substrate 102, mesa 120 having a patterning surface 122 thereon. Further, mesa 120 may be referred to as mold 120. Template 108 and/or mold 120 may be formed materials including, but not limited to, fused-silica, quartz, silicon, organic polymers, siloxane polymers, borosilicate glass, fluorocarbon polymers, metal, hardened sapphire, and/or the like. As illustrated, patterning surface 122 comprises features defined by a plurality of spaced-apart recesses 124 and/or protrusions 126, though embodiments of the present invention are not limited to such configurations. Patterning surface 122 may define any original pattern that forms the basis of a pattern to be formed on substrate 102.

Template 108 may be coupled to chuck 128. Chuck 128 may be configured as, but not limited to, vacuum, pin-type, groove-type, electromagnetic, and/or other similar chuck types. Exemplary chucks are further described in U.S. Pat. No. 6,873,087, which is hereby incorporated by reference. Further, chuck 128 may be coupled to imprint head 130 such that chuck 128 and/or imprint head 130 may be configured to facilitate movement of template 108.

System 100 may further comprise a fluid dispensing system 132. Fluid dispensing system 132 may be used to deposit polymerizable material 134 on substrate 102. Polymerizable material 134 may be positioned upon substrate 102 using techniques such as, but not limited to, drop dispense, spin-coating, dip coating, chemical vapor deposition (CVD), physical vapor deposition (PVD), thin film deposition, thick film deposition, and/or the like. Polymerizable material 134 may be disposed upon substrate 102 before and/or after a desired volume is defined between mold 120 and substrate 102 depending on design considerations. Polymerizable material 134 may comprise a monomer as described in U.S. Pat. No. 7,157,036 and U.S. Patent Publication No. 2005/0187339, all of which are hereby incorporated by reference.

Referring to FIGS. 1 and 2, system 100 may further comprise an energy source 138 coupled to direct energy 140 along path 142. Imprint head 130 and stage 106 may be configured to position template 108 and substrate 102 in superimposition with path 142. System 100 may be regulated by a processor 154 in communication with stage 106, imprint head 130, fluid dispensing system 132, and/or source 138, may operate on a computer readable program stored in memory 156.

Either imprint head 130, stage 106, or both vary a distance between mold 120 and substrate 102 to define a desired volume therebetween that is filled by polymerizable material 134. For example, imprint head 130 may apply a force to template 108 such that mold 120 contacts polymerizable material 134. For example, as illustrated in FIG. 2, after the desired volume is filled with polymerizable material 134, source 138 produces energy 140, e.g., broadband ultraviolet radiation, causing polymerizable material 134 to solidify and/or cross-link conforming to shape of a surface 144 of substrate 102 and patterning surface 122, defining a patterned layer 202 on substrate 102. Patterned layer 202 may comprise a residual layer 204 and a plurality of features shown as protrusions 206 and recessions 208, with protrusions 206 having thickness t₁ and residual layer 204 having a thickness t₂.

The above-mentioned system and process may be further employed in imprint lithography processes and systems referred to in U.S. Pat. No. 6,932,934, U.S. Patent Publication No. 2004/0124566, U.S. Patent Publication No. 2004/0188381, and U.S. Patent Publication No. 2004/0211754, each of which is hereby incorporated by reference.

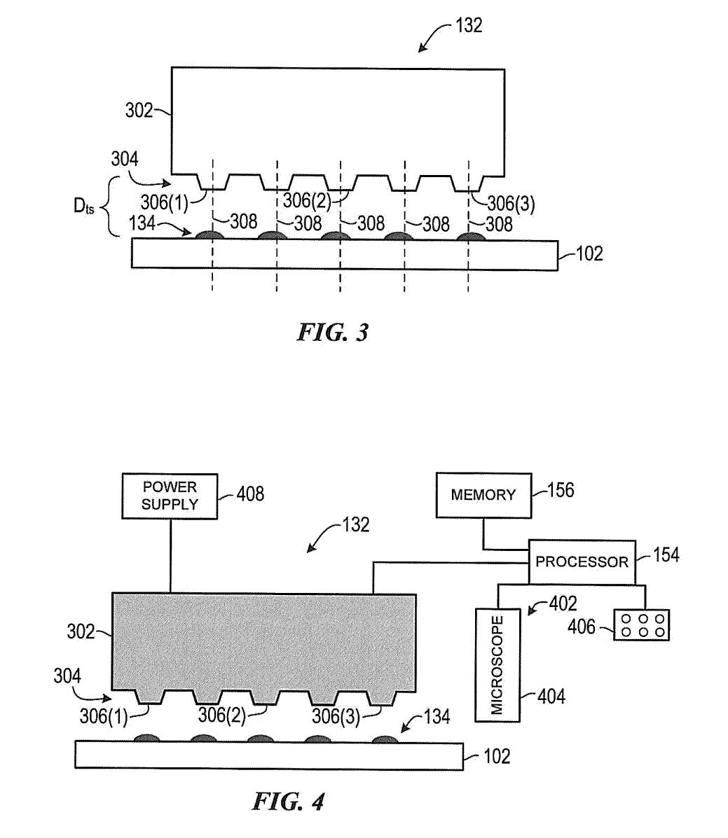

As described above, polymerizable material 134 may be positioned upon substrate 102. Fluid dispensing system 132 may be used to deposit polymerizable material 134 or other fluids. FIG. 3 illustrates a fluid dispensing system 132 comprising a dispense head 302 and a dispense system 304 for depositing polymerizable material 134 on substrate 102. Dispense head 302 may comprise micro-solenoid valves, piezo-actuated dispensers, MEMS based dispensers, ultrasonic base drop ejector, and the like. Piezo-actuated dispensers are commercially available from MicroFab Technologies, Inc., Plano, Tex.

As described above, polymerizable material 134 may be applied to the defined volume between template 108 and substrate 102 using a fluid dispense system 132. FIG. 3 illustrates an exemplary embodiment of fluid dispense system 132. Fluid dispense system 132 may comprise a dispense head 302 and nozzle system 304. Nozzle system 304 may comprise a single tip or a plurality of tips 306(1)-306(N) depending on design considerations. For example, FIG. 3 illustrates nozzle system 304 comprising a plurality of tips 306(1), 306(2), and 306(3). Polymerizable material 134 propagates through dispense head 302 and egresses from tip 306(N) of nozzle system 304. Tip 306(N) defines a dispensing axis 308 at which polymerizable material 134 may be deposited on substrate 102. The distance dᵢₛ between tip 306(N) and substrate 102 may be selected as to minimize, if not prevent splashing and/or drop location drifting; as well as to prevent gas from being present in polymerizable material 134 deposited on substrate 102. Nozzles 306(1)-306(N) may generally include a diameter range of 10 nm to 100 micron. Drop ejection may be at a frequency range of greater than about 1 KHz with a resolution of approximately 100 to 5000 dpi or more. Nozzle 306(N) opening may be approximately 80 microns or less with an approximate drop volume of about 1 picoliter to about 180 picoliters or less.

As illustrated in FIG. 4, fluid dispensing system 132 may optionally be connected to a vision system 402. Vision system 402 may comprise a microscope 404 (e.g. optical microscope) to provide images 406 of polymerizable material 134 placement on substrate 102. Microscope 404 may be controlled by processor 154 and further may operate on a computer readable program stored in memory 156. Images 406 may be provided at periodic intervals during the imprinting process. Further illustrated in FIG. 4, fluid dispensing system 132 may include a power supply 408 to provide an approximately applied voltage V to dispense droplets. Additionally, fluid dispensing system 132 may be controlled by one or more processors and one or more software generated programs stored in memory. For example, fluid dispensing system 132 may be controlled by processor 154. having a software-generated program stored in memory 156. It should be noted that fluid dispensing system 132 may use an external processor.

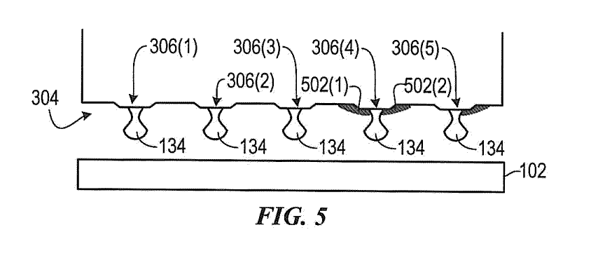

Polymerizable material 134 dispensing from nozzle system 304 may be subject to evaporation due to general air flow about system 100 and/or subjected to crosslinking or gelling when exposed to energy source 138 (as shown in FIG. 1). Evaporation may clog nozzle system 304 resulting in non-dispensing tips 306(N), poor polymerizable material 134 placement, filling defects, and the like. For example, FIG. 5 illustrates nozzle system 304 having multiple tips 306(1), 306(2), 306(3), 306(4), and 306(5) for dispensing polymerizable material 134. Evaporated polymerizable material 134 may deposit residue 502(1) and 502(2) adjacent to tips 306(4) and 306(5), respectively. Residue 502(1) and/or 502(2) may interfere with drop formation, interfere with drop placement, and/or contaminate polymerizable material 134 that will egress from tip 306(N).

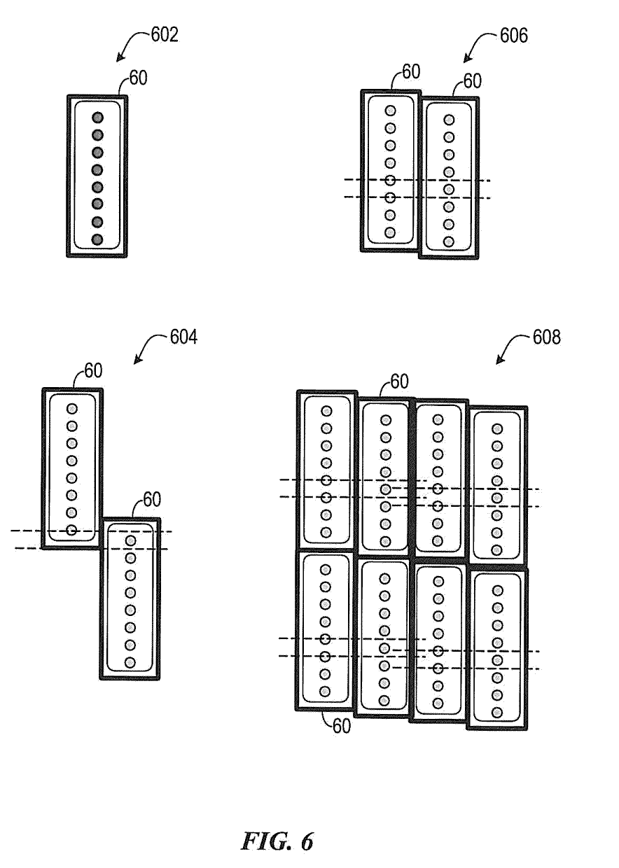

As discussed above, fluid dispensing system 132 may comprise a single dispense head 306 or multiple dispense heads 306(1) . . . 306(N). For example, FIG. 6 illustrates different configurations for a single dispense head 306 and multiple dispense heads 306(1) . . . 306(N) including a single configuration 602, a dual stitched configuration 604, a dual interlaced configuration 606, and a matrix configuration 608.

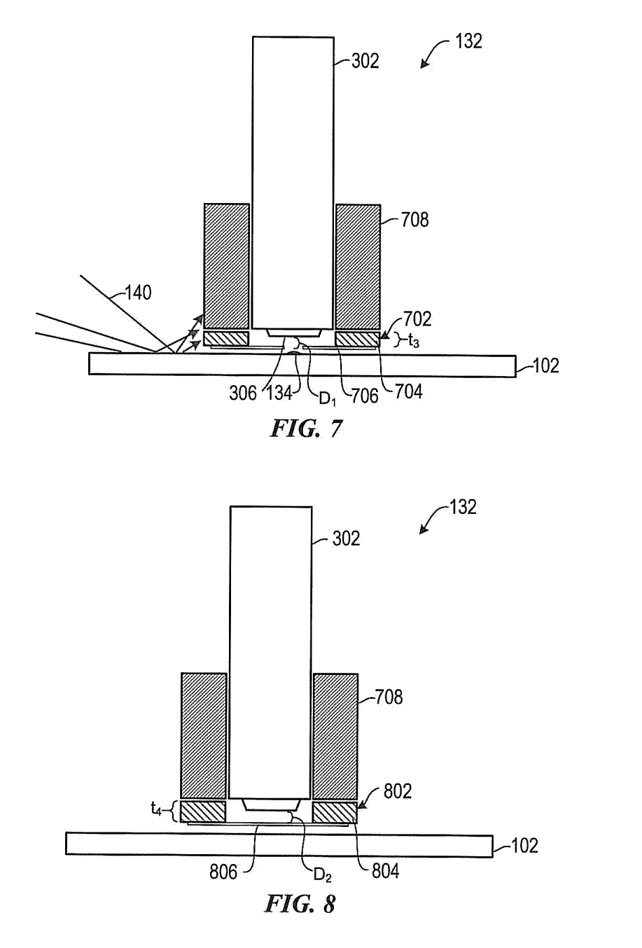

FIG. 7 and FIG. 8 illustrate a dispense head guard 702 and a dispense head cap 802, respectively, for reducing air flow about nozzle system 304 during imprinting. Dispense head guard 702 and dispense head cap 802 may be interchangeable such that dispense head guard 702 may be attached to fluid dispense system 132 when fluid dispense system 132 is in use and removed when fluid dispense system 132 is not in use for attachment of dispense head cap 802. Dispense head guard 702 and dispense head cap 802 may be formed of any material that is compatible with polymerizable material 134, for example, but not limited to, plastics, aluminum, stainless steel, and the like. Dispense guard 702 and dispense head cap 802 may be formed of materials substantially impermeable to UV light, such as, but not limited to, a non-transparent plastic, aluminum, and the like.

As illustrated in FIG. 7, dispense head guard 702 may comprise at least a base 704 and a guard plate 706. Base 704 may provide attachment of guard plate 706 to a mounting bracket 708 that supports dispense head 302. Alternatively, base 704 may attach guard plate 706 directly to dispense head 302. Base 704 may be designed with a thickness t₃ such that there is a set distance D₁ between guard plate 706 and nozzle tip 306. For example, base 704 may be designed with a thickness t₃ such that the distance D₁ between guard plate 706 and nozzle tip 306 is approximately between about 250 microns and about 750 microns.

As illustrated in FIG. 8, dispense head 802 may comprise a base 804 and a cap plate 806. Base 804 may provide attachment of cap plate 806 to mounting bracket 708 that supports dispense head 302. Alternatively, base 804 may attach cap plate 806 directly to dispense head 302. Base 804 may be designed with a thickness t₄ such that there is a set distance D₂ between cap plate 806 and nozzle tip 306. Cap plate 806 covers nozzle tip 306 during periods of use of system 100. For example, without limitation, cap plate 806 may cover nozzle tip 306 when system 100 is idle for twenty-four hours.

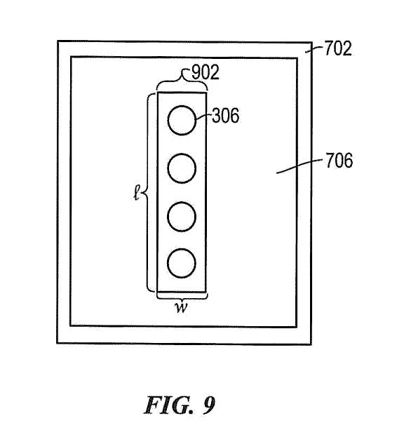

Guard plate 706 allows droplets of polymerizable material 134 to pass to substrate 102 while reducing air flow and/or blocking energy 140 about nozzle system 304. As illustrated in FIG. 9, guard plate 706 may comprise an opening 902 with a width w and a length/with magnitudes that may allow for nozzle tip 306 to provide polymerizable material 134 during use of system 100. Although only one opening 902 is shown, it should be appreciated that guard plate 706 may have any number of openings.

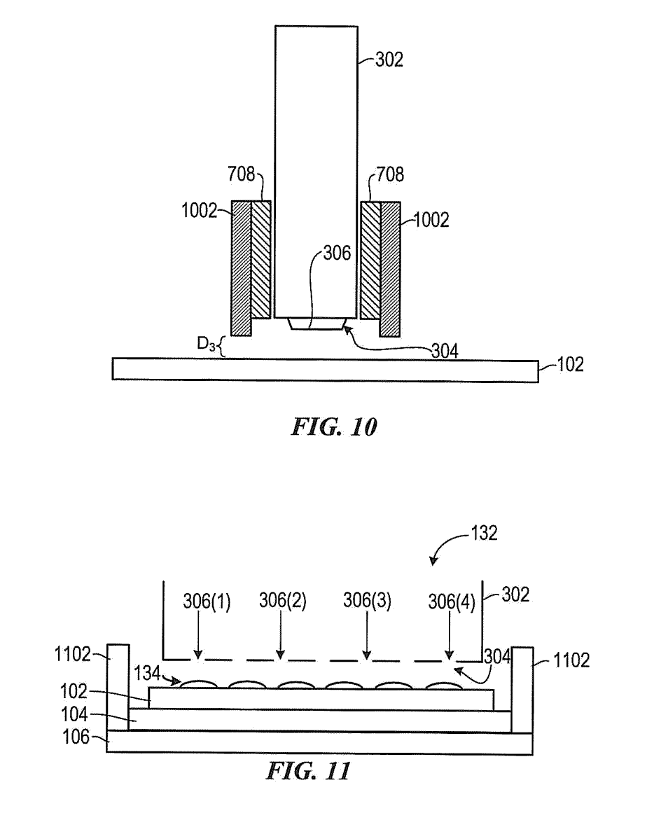

FIGS. 10 and 11 illustrate a shielding block 1002 and 1102, respectively, for reducing air flow and/or blocking energy 140. Specifically, FIG. 10 illustrates shielding block 1002 attached to fluid dispense system 132. In one implementation, shielding block 1002 may be attached to fluid dispense system 132 by an adhesive to mounting bracket 708, dispense head 302, or a combination of both. Alternatively, shielding block 1002 may be integrally formed to fluid dispense system 132 such that there is a distance D₃ between shielding block 1002 and substrate 102 during the imprint process. Distance D₃ may provide for substantial blockage of energy 140 (shown in FIG. 1) without contact of shielding block 1002 with substrate 102. For example, without limitation, shielding block 1002 may be placed a distance D₃ of about 750 microns.

As illustrated in FIG. 11, shielding block 1102 may provide re-direction of air flow and blocking of energy 140 (shown in FIG. 1) without shielding block 1102 being attached to fluid dispense system 132. In one implementation, shielding block 1102 may be attached to stage 106. Alternatively, shielding block 1102 may be attached to chuck 104, a bridge of the imprint process, and/or to a helium skirt.

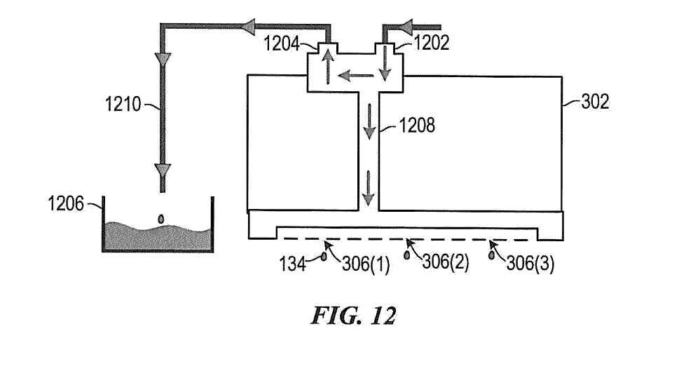

FIG. 12 illustrates dispense head 302 having an inlet port 1202 and an outlet port 1204 wherein the outlet port 1204 may be connected to a wasted disposal system 1206 for collecting and evaluating gases. Polymerizable material 134 flows through inlet port 1202 and propagates through channel 1208 to egress from nozzle tip 306. Gases within dispense head 302 or at nozzle tip 306 may interfere with the propagation of polymerizable material 134 through channel 1208 and/or nozzle tip 306. Having outlet port 1204 connected to waste disposal system 1206 by channel 1210 may provide a mechanism to collect and evaluate gases.

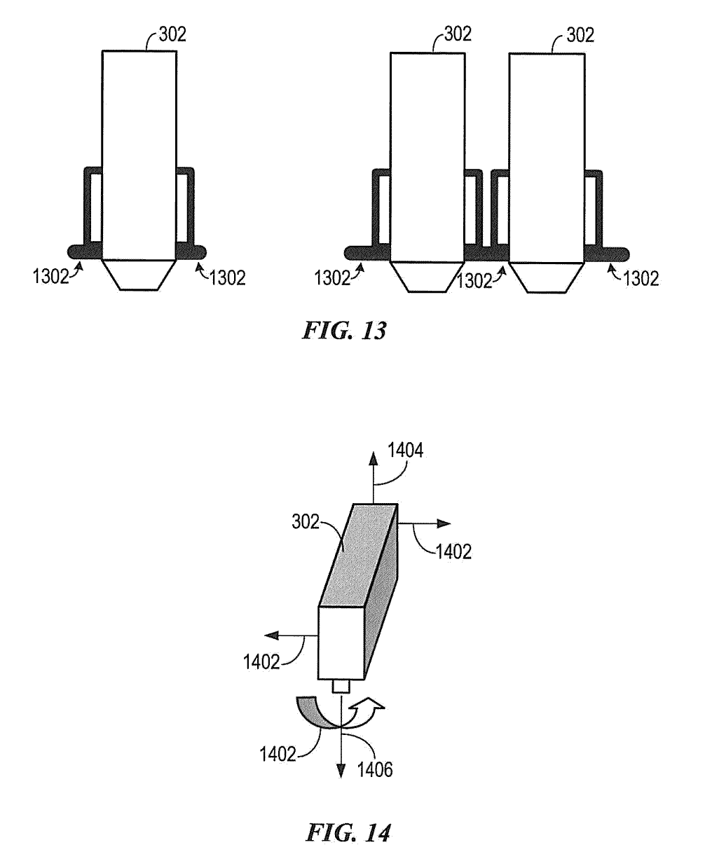

As shown in FIG. 13, single and multiple dispense head 302 may be mounted using mounting hardware 1302. In one implementation, as illustrated in FIG. 14, mounting hardware 1302 may provide for adjustments for a theta motion 1402, a roll motion 1404, and a pitch motion 1406 between multiple dispense heads 302. Alternatively, other configurations for mounting hardware 1302 may be used.

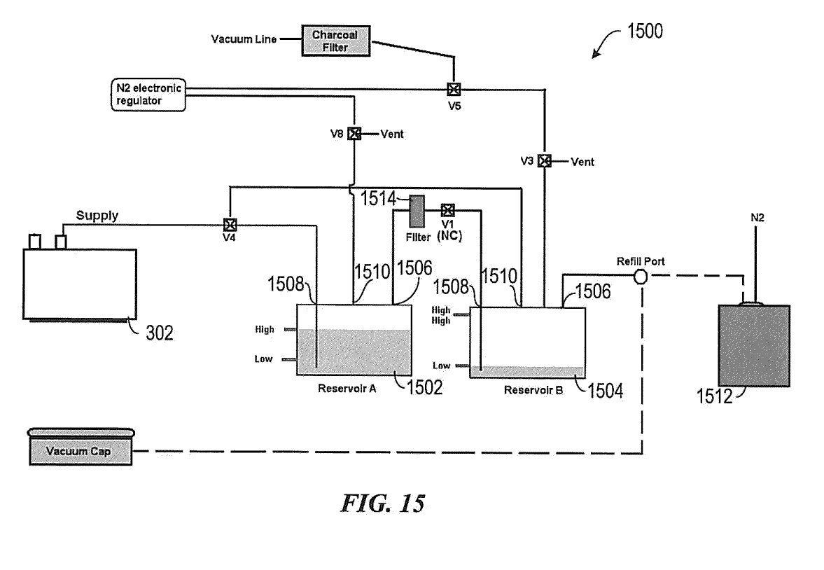

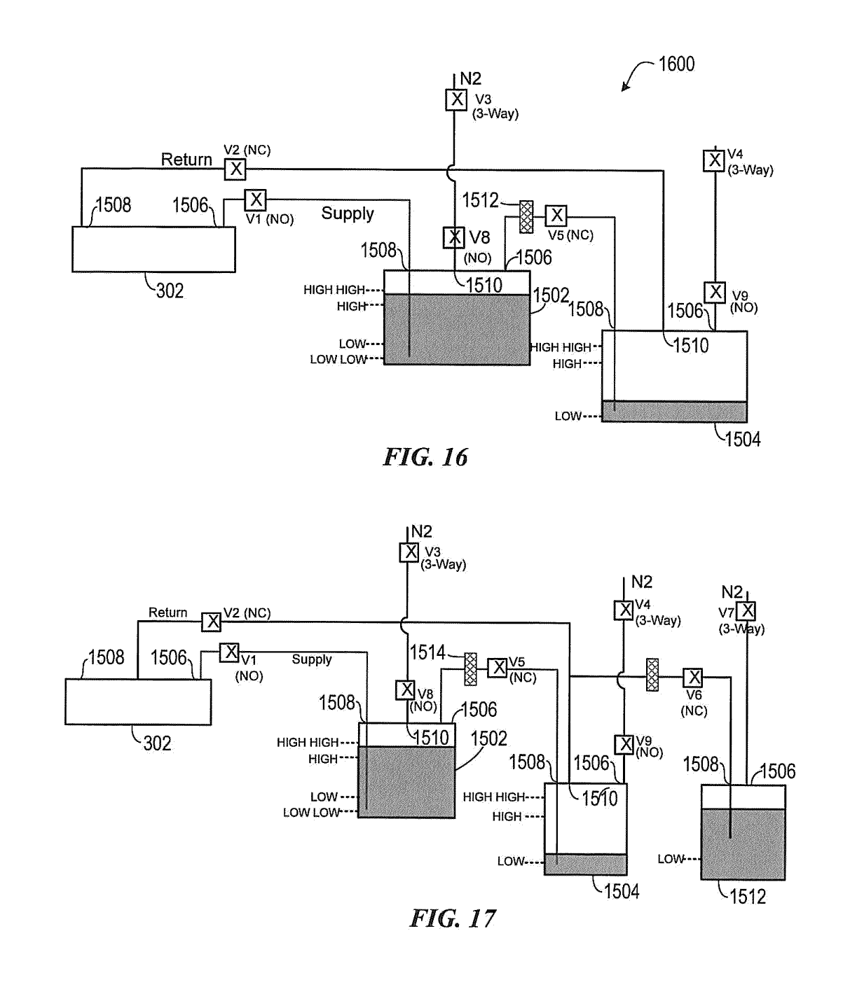

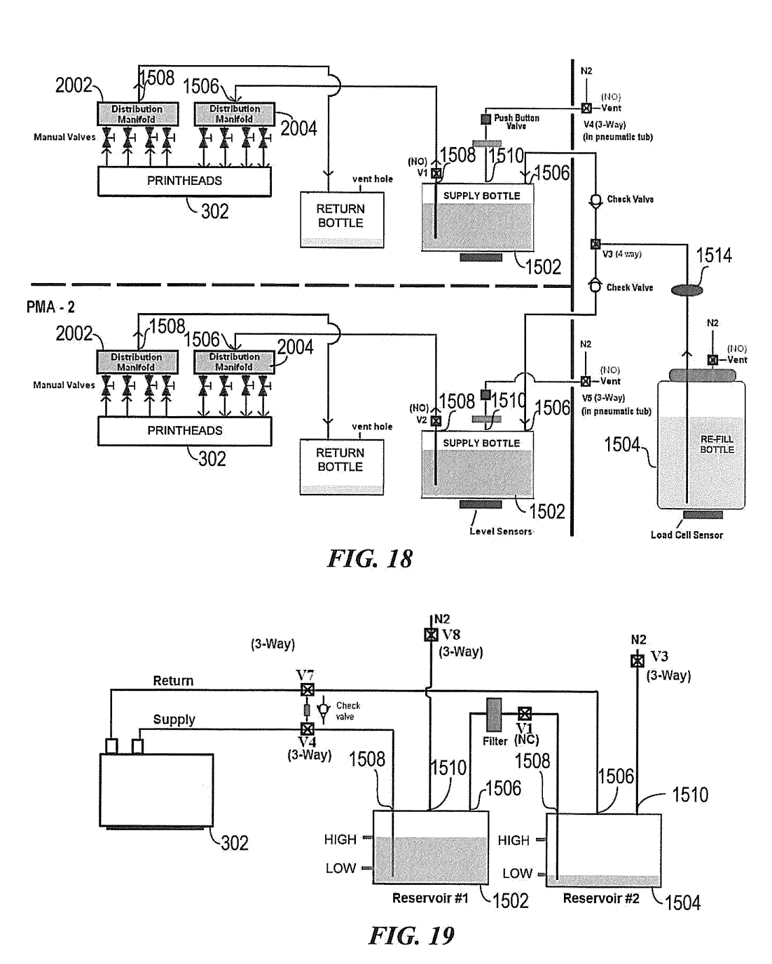

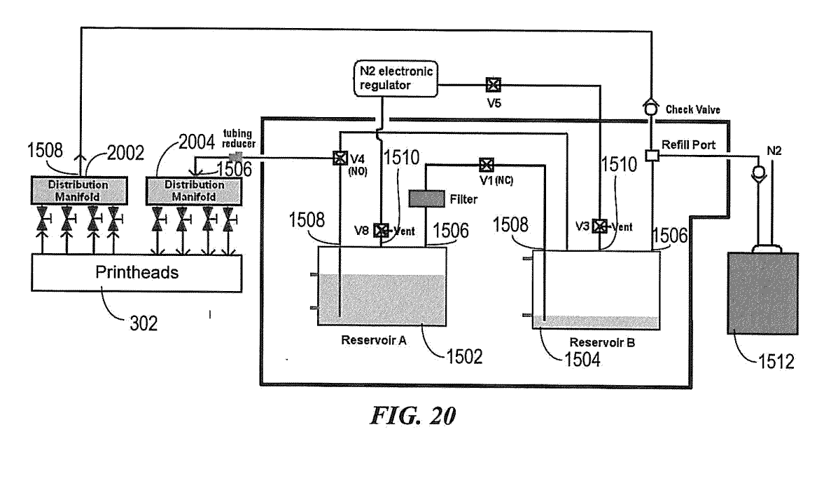

FIGS. 15-20 illustrate exemplary fluid transport system 100 that be used to provide fluid to dispense head 302. As shown in the figures, generally, fluid transport system 1500 may include one or more fluid supply reservoirs 1502 to supply fluid to dispense head 302, and one or more fluid return reservoirs 1504 to accept fluid from dispense head 302. Reservoirs 1502 and/or 1504 may be about 150 mL. Additionally, reservoirs 1502 and/or 1504 may include three ports: inlet port 1506, outlet port 1508, and venting port 1510. Inlet port 1506 may receive fluid, outlet port 1508 may provide fluid, and venting port 1510 may be provided to regulate pressurization within reservoir 1502 and/or 1504. Reservoir 1502 and/or 1504 may include level sensors for maintaining a pre-determined amount of fluid within the reservoir 1502 and/or 1504. Additionally, transport system 100 may include a re-fill reservoir 1512 in fluid communication with reservoir 1502 and/or 1504.

Reservoirs 1502 and/or 1504 may be made of substantially ion free materials. For example, reservoirs 1502 and/or 1504 may be made of Teflon, FEP, and/or the like. Materials selected for use in reservoirs 1502 and/or 1504 may yield the following purity grade: equal to or less than 10 ppb (semiconductor grade) and/or equal to or less than 25 ppL (electronic grade).

Fluid may be transported between reservoirs 1502 and/or 1504 and dispense head 302 through tubing, valves, fittings, and the like. Tubing, valves, and fittings may be made of materials similar to reservoirs 1502 and/or 1504. Tubing may be isolated from vibration so as not to disrupt flow. For example, tubing may be anchor to mounts within transport system 1500.

Transport system 1500 may include filters 1514. Filters 1514 may be placed at locations where fittings and valve connections are made, at locations where fluid may be received by reservoirs 1502 and/or 1504, and/or at locations where fluid may be provided by reservoirs 1502 and/or 1504. Placement of filters 1514 may be designed for particle reduction and/or ion reduction at locations where fittings and/or connections are made to direct fluid to dispense head 302. An example filter 1514 mesh or pore size is approximately 45 microns.

Transport system 1500 may include degassers for removing dissolved gases. Removal of gasses by degassers may reduce the occurrences of bubbles within the dispense head 302 and/or reduce gases being dispensed by dispense head 302 that may result in defects in the imprinting process. Generally, degassers may be located between reservoirs 1502 and/or 1504 and dispense head 302. Additionally, tubing may include bubble sensors for identifying air pockets. For example, bubble sensors may be capacitive sensors, laser sensors, and/or the like.

Transport system 1500 may include an in-line manifold 2002. Manifold 2002 may provide distribution of fluid from reservoirs 1502 and/or 1504 to dispense head 302.

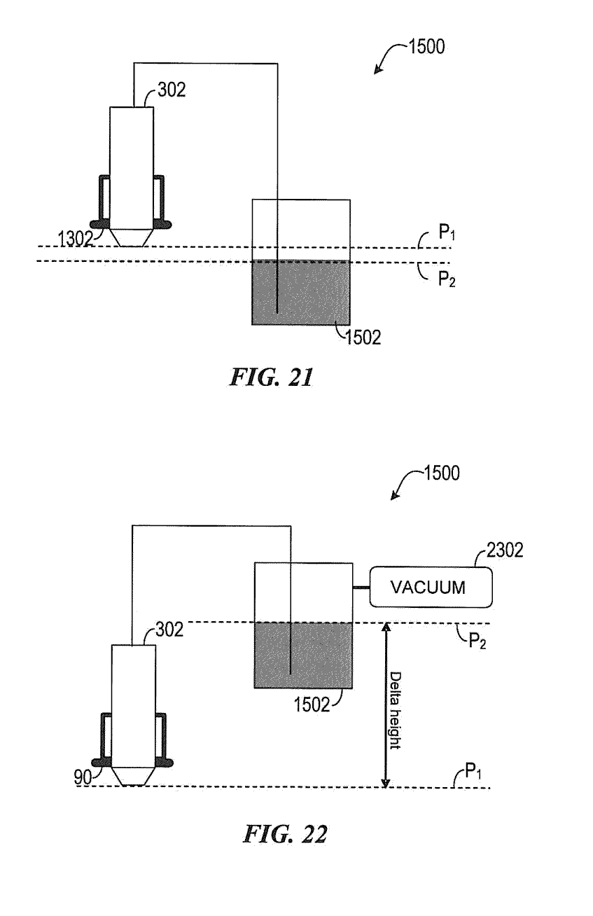

FIGS. 21-23 illustrate methods for providing fluid to dispense head 302 by transport system 1500. For example, FIG. 21 illustrates transport of fluid by a gravity feed technique. In using the gravity feed technique, fluid travels to dispense head 302 by surface tension. Reservoir 1502 and/or 1504 may be located below the plane P₁ of the dispense system 304, thus providing a distance d₁ between the plane P₁ of the dispense system 304 and plane P₂ of reservoir 1502 and/or 1504.

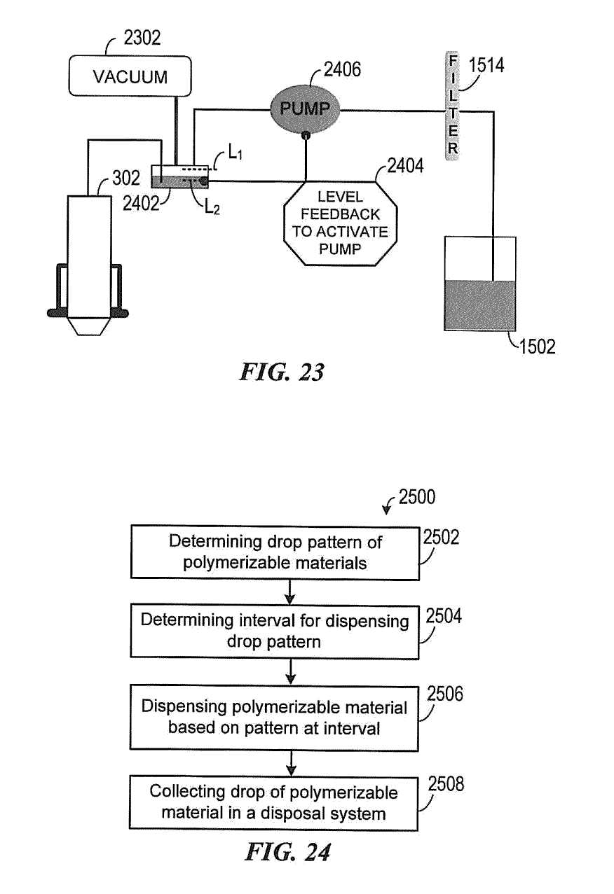

FIG. 22 illustrates transport of fluid by active flow. For example, the vacuum 2302 may provide a force to transport fluid to dispense head 302. As such, the plane P₂ of reservoir 1502 and/or 1504 may be above the plane P₁. FIG. 23 illustrates another example of active flow. In this example, a header tank 2402 having a level sensor 2404 may be used. Header tank 2402 may contain a fill level L₁ and a low level L₂. As fluid is transported from the header tank 2402 to dispense head 302, level sensor 2404 may determine the level of header tank 2402. If level sensor indicates header tank is at low level L₂, a pump 2406 may provide fluid from reservoir 1502 and/or 1504 to fill header tank 2402 to level L₁. In addition, a secondary pump may be placed on the return supply line at outlet port 1508 to assist with transferring fluid back from dispense head 302 to reservoirs 1502, 1504, 2402 and/or 1512. Pumps may be constructed of ion-free material, such as Teflon, or like materials. Pumps may be constructed such that there is limited particle generation when actuated.

FIG. 24 is a flow chart of an exemplary method 2500 for dispensing droplets of polymerizable material 134 to prevent clogging of nozzle system 304. In a step 2502, a drop pattern of polymerizable material 134 may be determined. Drop pattern may constitute any number of drops of polymerizable material 134 in any original pattern. In one implementation, the drop pattern may consist of 100 drops of polymerizable material 134. In a step 2504, an interval for dispensing the drop pattern from fluid dispense system 132 may be determined. The interval may be a time at which the imprint process is idle. In one implementation, imprint process 100 may be idle for three minutes and active for thirty minutes. The interval for dispensing drop patterns may be during the three minute idle time. In a step 2506, drops of polymerizable material 134 may be dispensed by the nozzle system based on drop patterns at the interval. In a step 2508, drops of polymerizable material 134 may be collected by a disposal system. Disposal systems, may include, but are not limited to, waste containers, vacuum systems, and the like.

As previously discussed, polymerizable material 134 propagates through dispense head 302 and egresses from nozzle tip 306 of nozzle system 304. Gases within dispense head 302 or at nozzle tip 306 may interfere with the propagation of polymerizable material 134 through the dispense head 302.

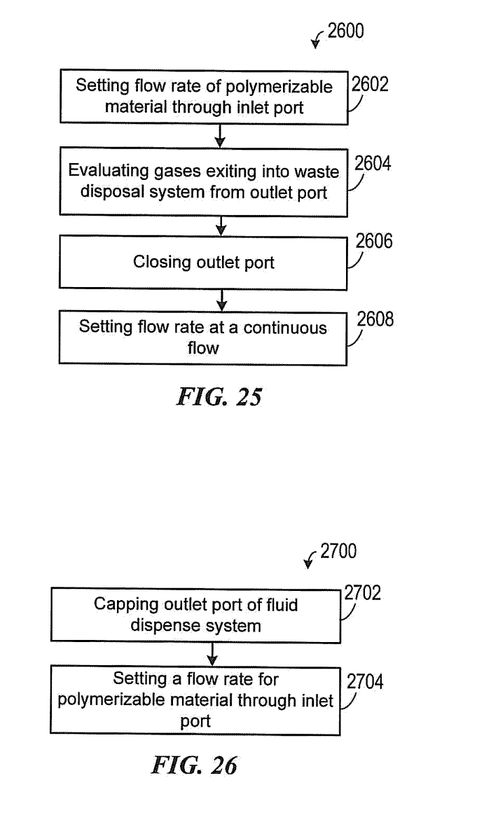

FIG. 25 illustrates a flow chart of an exemplary method 2600 using the fluid dispense system 132 of FIG. 12 connected to waste disposal system 1208 to collect and evaluate gases. In a step 2602, polymerizable material 134 may be set to flow through inlet port 1202. The flow rate through inlet port 1202 may be such that a small amount of polymerizable material 134 may exit through nozzle tip 306 and may exit through outlet port 1204 to waste disposal system 1206. In one implementation, polymerizable material 134 may be set to flow through inlet port 1202 by pressurization of up to 3 bars. In a step 2604, polymerizable material 134 may be evaluated using a bubble sensor. Alternatively, polymerizable material 134 may be evaluated by a user. In a step 2606, outlet port 1204 may be closed in the absence of substantial gas exiting waste disposal system 1206 from channel 1210 at approximately less than one gas bubble per sec for a flow rate of approximately no more than 20 mL/sec. In a step 2608, polymerizable material 134 may be set to continue to flow through inlet port 1202. In one implementation, the flow rate through inlet port 1202 may be set at a pressure of no greater than 3 bars. In a step 2610, nozzle tip 306 of nozzle system 304 may be blotted. In one implementation, nozzle tip 306 may be blotted using a polyknit wipe. Alternatively, nozzle tip 306 may be blotted using a tube vacuum.

FIG. 26 illustrates a flow chart of an exemplary method 2700 for flushing fluid dispense system 132. In a step 2702, outlet port 1204 of fluid dispense system 132 may be capped. In a step 2704, polymerizable material 134 may be set to a flow rate through inlet port 1202. The flow rate of polymerizable material 134 may be set such that turbulence is not created within polymerizable material 134. In one implementation, the flow rate of polymerizable material 134 may be based on a pressure on no more than 3 bars.

1. A method of nano-scale pattern replication on a substrate, the method comprising:
determining a drop pattern of a polymerizable material to be positioned on the substrate;
determining a time interval for dispensing the polymerizable material from one or more printheads of a fluid dispensing system in accordance with the drop pattern; and
collecting one or more drops of the polymerizable material during dispensation in a disposal system for evaluation.

2. The method of claim 1, wherein the drop pattern comprises approximately 100 or more drops of polymerizable material with a drop ejection rate of at least about 1 kilohertz and with a resolution of about 100 dots per inch (DPI) to about 5000 DPI.

3. The method of claim 1, wherein the dispense is idle for an approximate period of time of about two minutes or greater.

4. The method of claim 3, wherein the time interval for dispensing the polymerizable material is during the time that the imprint process is idle.

5. The method of claim 1, wherein the fluid dispensing system is controlled by at least one of a program stored in a computer-readable storage media and one or more processors.

6. A system for dispensing a polymerizable material comprising:
one or more dispense heads delivering the polymerizable material through the system to a substrate;
a nozzle system coupled to each of the one or more dispense heads, wherein each nozzle system comprises a nozzle tip;
a dispense head guard and a dispense head cap coupled to each of the one or more dispense heads; and
an integral shielding block such that there is a distance D between the integral shielding block and the substrate during an imprint process.

7. The system of claim 6, wherein the dispense head guard and the dispense head cap comprise a material substantially impermeable to ultraviolet light.

8. The system of claim 6, wherein the dispense head guard comprises at least a base and at least a guard plate, wherein the base has a thickness T₃ such that there is a distance D₁ between the guard plate and the nozzle tip ranging from about 250 microns to about 750 microns.

9. The system of claim 8, wherein the guard plate comprises an opening permitting the polymerizable material to pass through to the substrate.

10. The system of claim 6, wherein the distance D is about 750 microns.

11. The system of claim 6, wherein the nozzle tip comprises:
a diameter ranging from about 10 nanometers to about 100 microns;
a drop volume ranging from about 1 femtoliter to about 180 picoliters.

12. The system of claim 6, wherein the polymerizable material has a drop ejection rate no less than 1 kilohertz and with a resolution of about 100 dots per inch (DPI) to about 5000 DPI.

13. The system of claim 6, wherein the one or more printheads are configured as a single dispense head, a dual stitch configuration, a dual interlaced configuration, or a matrix configuration.

14. The system of claim 6 further comprising one or mounting hardware enabling the one or more printheads to perform a theta motion, a roll motion, or a pitch motion.

15. The system of claim 6, wherein the system is controlled by at least one of a program stored in a computer-readable storage media and one or more processors.

16. A fluid transport system providing a polymerizable material to a dispense head in a system, the fluid transport system comprising:
one or more fluid supply reservoirs to supply the polymerizable material to the dispense head;
one or more fluid return reservoirs to accept the polymerizable material from the dispense head;
an inline manifold coupled to each of the fluid supply reservoirs distributing the polymerizable material to the dispense head or from the dispense head;
one or more degassers located between the one or more fluid supply reservoirs and the one or more fluid return reservoirs; and
one or more filters positioned in the inline manifold for particle reduction or ion reduction.

17. The system of claim 16, wherein each of the one or more fluid supply reservoirs and each of the one or more fluid return reservoirs comprises an inlet port, an outlet port, and a venting port.

18. The system of claim 16, wherein the fluid transport system is a gravity feed system such that the one or more fluid supply reservoirs or the one or more fluid return reservoirs are positioned below a plane P₁ of a dispense system providing a distance d₁ between the P₁ of the dispense system and a plane P₂ of the one or more fluid supply reservoirs or the one or more fluid return reservoirs.

19. The system of claim 16, wherein the fluid transport system is an active flow system such that a plane P₂ of the one or more fluid supply reservoirs or the one or more fluid return reservoirs are above a plane P₁.

20. The system of claim 16, wherein the fluid transport system is an active flow system further comprising:
a vacuum to transport the polymerizable material from a header tank to the dispense head, the header tank comprising:
a level sensor to determine the level of the polymerizable material in the header tank;
a fill level L1; and
a low level L2; and
a pump enabling the polymerizable material to be transferred from the one or more fluid supply reservoirs or the one or more fluid return reservoirs to the header tank.
